(19) United States
(12) Patent Application Publication
(10) Pub. No.: US 2024/0176673 A1
(43) Pub. Date: May 30, 2024

(54) SYSTEMS AND METHODS FOR AUTOMATION DISCOVERY AND ANALYSIS USING ACTION SEQUENCE SEGMENTATION

(71) Applicant: Nice Ltd., Ra'anana (IL)

(72) Inventors: Eran ROSEBERG, Hogla (IL); Yuval SHACHAF, Even Yehuda (IL); Oz GRANIT, Ramat-Gan (IL)

(73) Assignee: Nice Ltd., Ra'anana (IL)

(21) Appl. No.: 18/072,349

(22) Filed: Nov. 30, 2022

(51) Int. Cl. G06F 9/50

(52) U.S. Cl. CPC G06F 9/5061

(57) ABSTRACT

A computerized system and method may generate computer automation opportunities based on segmenting action sequences from action data and/or information items. A computerized system including a processor or a plurality of processors, and a memory including a data store of a plurality of data items describing actions input to a computer may be used to receive an input query or a plurality of actions input to a computer; segment action sequences from the stored data items based on the query; and produce automation candidates based on the segmented sequences. Embodiments of the invention may include generating, by a machine learning model, vector embeddings for action sequences, calculating similarity scores for sequences based on the embeddings, and mining a plurality of action subsequences based on, a group or set of similar sequences, as well as additional and/or auxiliary procedures and operations.

### FIELD OF THE INVENTION

The present invention relates generally to automation of computer processes previously performed by users; in particular to identifying groups of tasks and/or routines into processes that may be chosen as candidates for automations.

### BACKGROUND OF THE INVENTION

Companies and organizations such as call centers, or other businesses, may identify (e.g. “discover”) business processes or “flows” that are significant candidates for robotic process automation (RPA), in that they are both feasible for automation and that automation would have high potential return on investment (ROI) by saving significant manual efforts and workloads when being handled by automated computer processes, which may be performed by “bots”, or robots, instead of human agents. Such automation opportunities may involve human-computer interactions. A bot created to replace or automate human-computer interactions may be an autonomous program that may interact with computer systems, programs, or users, and which may operate as would a human user.

In some approaches used in the art, this discovery and analysis process is sometimes done manually, which may be subjectively-biased, time consuming and very expensive. Thus, various methods exist, machine based, human based, and machine-human hybrids, to find automation opportunities. Technologies such as process mining tools may use high-level system-specific event logs as input data, such as case identification (ID) (e.g. Process ID), activity ID and, timestamp to identify automation opportunities. Received log data may be, by definition, labeled (labels exists in the data gathered from the event logs) making it much simpler to analyze automatically. A case ID may identify the process instance and an activity ID may specify the task that has been performed as part of the process. It should be noted, however, that such data is typically provided by the application itself and may not be provided for all applications. In addition, data such as an activity ID, user selection and input may be data internal to a program and may not be provided to other programs. Thus, some of the shortcomings of many process-mining procedures may be rooted in the lack of complete data/information on, e.g., multi-program processes; and the crucial part that a process must be chosen manually as a potential candidate for process automation in advance.

Some recent approaches may allow recording low-level event data that may not be associated with a specific process (e.g. case ID) or activity, but rather with a desktop window which has a name and with a program or application operating the window (e.g. an internet browser)—and then identify routines and processes based on, e.g., unsupervised-learning-based analysis of recorded data. Such broad data gathering process may mitigate the two shortcomings noted above. However, approaches based on using noisy and untagged user desktop actions as input data pose a great challenge in the context of grouping discovered tasks and/or routines into meaningful maps describing processes that may be chosen as candidates for automation. Thus, different methods and procedures combined with a low-level event data based approach, and employing, for example, state of the art machine learning techniques, may greatly help correctly identifying automation opportunities by making inferences and predictions based on appropriate amounts of input action data.

### SUMMARY OF THE INVENTION

A computerized system and method may produce or generate a plurality of computer action, routine, or process automation opportunities based on segmenting or indexing action sequences from action data and/or information items. A computerized system including a processor or a plurality of processors, a communication interface to communicate via a communication network with one or more remote computing devices, and a memory including a data store of a plurality of data items describing actions input to a computer (which may, for example, be received from a plurality of remote computing devices over the communication network)—may be used to receive an input query describing a process or a plurality of actions input to a computer; segment a plurality of action sequences from the data items based on the query; and produce automation candidates based on the sequences (which may be, for example, a set of sentences found similar to the query). A “sentence” may be for example a string or text representation of a sequence of actions, where actions may be data describing computer events.

Embodiments of the invention may perform additional or auxiliary procedures and/or operations and thus, for example, encode action sequences into one or more strings or sentences; label a plurality of sequences or sentences as matching the query; train a machine learning (ML) model based on the sentences and generate, by the model, vector representations for sentences; calculate similarity scores for pairs of sequences and group similar sentences based on the scores; mine a plurality of action subsequences from, or based on, a group or set of similar sequences; transmit an instruction to a plurality of remote computers to automatically execute a computer operation based on automation candidates; display a report (including, for example, a plurality of automation candidates) on a graphical user interface (GUI) of a remote computer; and the like, as demonstrated herein.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device which may be used with embodiments of the invention.

FIG. 2 shows an example input query and corresponding output matches to the query which may be used and/or produced by embodiments of the invention.

FIG. 3 illustrates an example workflow including different component and modules which may be used as in some embodiments of the invention.

FIG. 4 illustrates an example S2V model training procedure according to some embodiments of the invention.

FIG. 5 depicts an example data preprocessing and model training procedure which may be used in some embodiments of the invention.

FIG. 6 depicts an example approximate match segmentation procedure according to some embodiments of the invention.

FIG. 7A-B depict an example report GUI visualization according to some embodiments of the present invention.

FIG. 8 is a flowchart depicting a simple automation discovery and analysis procedure according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may provide a method for automation discovery using computer action sequence segmentation or indexing. For example, in a computerized system including a processor or a plurality of processors, and a data store of a plurality of data items describing actions input to a computer, embodiments of the invention may be used to perform one or more of the following steps: receive an input query describing a process or a plurality of actions input to a computer; segment a plurality of action sequences from the data items based on the query; and produce one or more automation candidates based on the sequences (which may be, in some embodiments, a set of sentences found similar to the query). As part of these steps, embodiments of the invention may, for example, further perform one or more of: encode sequences into one or more strings or sentences; label a plurality of sequences or sentences as matching the query; train a machine learning (ML) model (which may include, for example, one or more neural networks (NNs) of varying numbers of layers) based on the sentences; generate, by the model, vector representations for sentences; calculate similarity scores for pairs of sequences (which may include, for example, measuring a distance between a pair of vector representations or embeddings generated for the corresponding sequences) each pair including, e.g., a labeled sequence and an unlabeled sequence, and add the unlabeled sequence to a set of similar sequences if the similarity score exceeds a predetermined threshold; mine a plurality of action subsequences from, or based on, the set of similar sequences; transmit an instruction to a plurality of remote computers to automatically execute at least one computer operation based on automation candidates; display a report (including, for example, a plurality of automation candidates) on a graphical user interface (GUI) of a remote computer; and the like, as demonstrated herein.

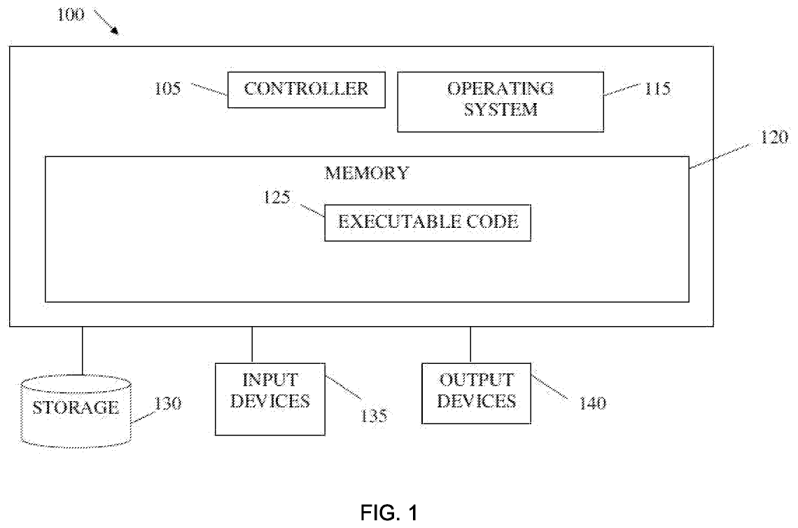

FIG. 1 shows a high-level block diagram of an exemplary computing device which may be used with embodiments of the invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of the procedures and/or calculations discussed herein may be or include, or may be executed by, a computing device such as included in FIG. 1, although various units among these modules may be combined into one computing device. For example, computer systems receiving low-level action input from a person, servers managing calls or interactions, ML models (e.g. a S2V model), a routine mining module, bots, and other modules as discussed may be executed by a system such as shown in FIG. 1.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data such as low level action data, output data, etc.

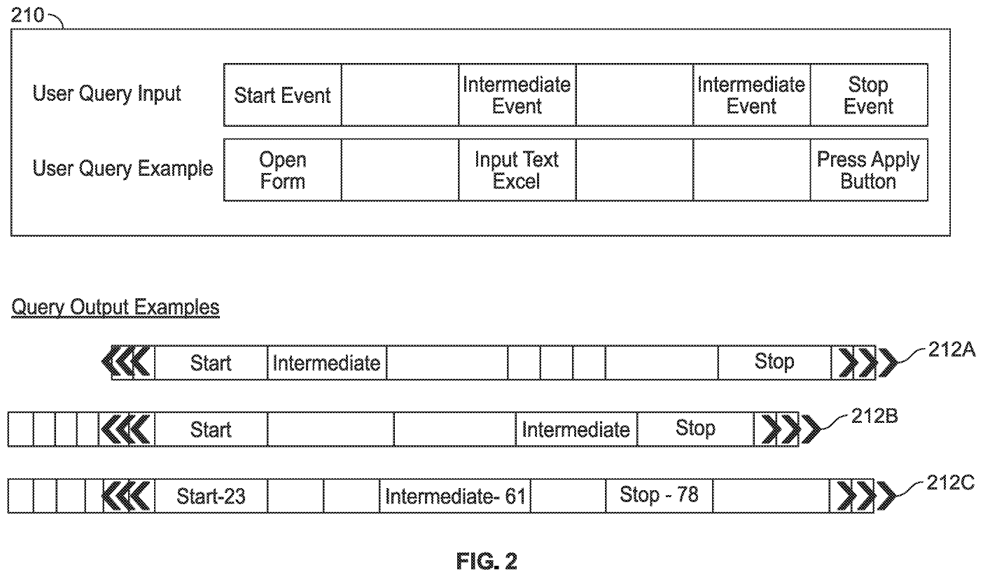

Executable code 125 may be any executable code, e.g., an application, a program, a process, task or script. Executable code 125 may be executed by controller 105 possibly under control of operating system 115. For example, executable code 125 may be one or more applications and/or modules performing methods as disclosed herein, such as, e.g., ones described in FIGS. 2-8. according to embodiments of the invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data and/or information items such as user action data or output data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless communication interface or network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may generally be applied to analyzed data (e.g. low-level user action information data items, which may for example be stored in memory 120) describing actions of human-computer interaction, such as user input events or actions to a graphical user interface (GUI) and used in, e.g., an automation discovery procedure. An example such procedure (to be denoted AD herein) used as part of the Automation Finder system and associated automation framework by NICE, Ltd. will be used as a non-limiting example throughout, although those skilled in the art will recognize that the invention may as well be applies to different procedures and approaches as well.

Low-level user action as used herein (e.g., as used in automation frameworks and procedures such as AD) may refer both to the action itself, typically input by a user received by a computer, and the data that describes such an action, and in addition a generalized description or name for the action which applies to multiple specific “instances” or “occurrences” of the same action or similar ones (in terms of their functionality) in information and/or data describing user actions, such as user action data and/information items as considered herein. While the present disclosure will be focused on lower-level user actions, it should be noted that embodiments of the invention may also be applied to different kinds of actions or tagged/untagged data describing computer input or user actions which may be, e.g., sorted by execution time.

A low-level user action or low-level user action item may be for example a mouse or other pointing device click, a keyboard input to a text field, a cut command, a paste command, a certain keystroke or set of keystrokes (e.g. ctrl-P, alt-F1, etc.). Data describing such user actions (e.g. a low-level user action item) may include for example the type or description of action item or an input item description (click, cut, paste, text entry, etc.); action component details (e.g. the title of window item to which input is applied, e.g. the name of the text field having text entered; the title of the button or control being clicked on, etc.); a user name or ID (e.g. the name of ID of the person providing the input or logged in to the computer or terminal); a time or timestamp of the action; screen window information such as the title of the screen window into which data is entered or on which the relevant data is displayed, and the name of the program or application executing with which the user is interacting (e.g. the program displaying the window such as the Internet Explorer browser).

A window may be for example a defined sub-area of the screen which may typically be resized and moved by a user, in which data is displayed and entered for a particular task or software program. For the point of view of the computer by which a window is displayed, a window may be a graphical control element including a visual area with a graphical user interface for the program it belongs to, typically rectangular. A window typically has a name displayed, typically at its top—for example, a window allowing a user to edit a text document may have a name or title including the filename of the document and the program being used to edit the document. A window may be related to two different software programs: the name of the program or application executing the window, such as a browser such as Internet Explorer; and a remote or local program which controls or owns the substance of the window.

The local or remote program executing the substance of the window may not provide adequate data, and thus embodiments may capture low level action data instead. In many cases, the name or title for a window may be accessible from the OS of the computer executing the program owning or displaying the window, while the program owning or displaying the window may not allow or provide access regarding its own name, function, etc. via system-specific event logs.

A system collecting low-level user action data and/or information, e.g., as part of the AD framework, may be illustrated in the context of a contact center, although embodiments of the invention may be used in other contexts. In such center, a number of human users such as call-center agents may use agent terminals which may be for example personal computers or terminals. Terminals may include one or more software programs to operate and display a computer desktop system (e.g. displayed as user interfaces such as a GUI). In some embodiments, software programs may display windows, e.g. via desktop system, accept user input (e.g. via the desktop system) and may interface with server software, e.g. receiving input from and sending output to software programs. Client data collection software, e.g., the NICE RT™ Client software, an Activity Recorder or Action Recorder, may execute on or by the terminals and may monitor input to different programs running on them. For example, client data collection software may receive, gather, or collect a user's desktop activity or actions, e.g., low-level user action information or descriptions, and send or transmit them to a remote server, e.g., a NICE RT™ Server.

The client data collection software may access or receive information describing user input or actions via for example an API (application programming interface) interface with the operating system and/or specific applications (e.g., the Chrome browser) for the computer or terminal on which it executes. The remote server may collect or receive data such as user action information or descriptions, combine actions into a file, and export them as for example JSON (JavaScript Object Notation) files or data objects via for example an HTTPS (Hypertext Transfer Protocol Secure) connection to an automation finder server, which may receive and store action data and other data in a database, which may then be processed. In some embodiments the remote server and automation finder server may be contained in or executed on the same computing device, unit, or server. One or more computer networks (e.g., the internet, intranets, etc.) may connect and allow for communication among the components of an automation discovery or finding system (such as the remote and automation finder servers, the agent terminals, and so forth). Agent terminals may be or include computing or telecommunications devices such as personal computers or other desktop computers, conventional telephones, cellular telephones, portable or tablet computers, smart or dumb terminals, etc. Terminals and servers discussed herein may include some or all the components such as a processor shown in FIG. 1.

In some embodiments, the client data collection software may operate with permission of, e.g., an organization's operating terminals, and may collect for example user input event data, and may be tuned or configured to not collect certain data. For example, a user may configure the data collection software to operate on or collect data from only certain windows and applications (e.g. windows with certain titles, or certain URLs (uniform resource locators) or website addresses), and may ignore for example windows accessing certain URLs or website addresses. The client data collection software may collect data from Internet based windows and/or non-Internet based windows.

In some embodiments, low-level user action data collected may be in the form of Windows Handles and their properties as provided by Windows API (e.g., Win-32). The event logs files describing these data collected desktop events may be exported in a JSON format, using appropriate files, and transferred to a server. The data may include for example event or action time (e.g. start time, but end time may also be included); user details (e.g. name or ID of the person providing the action input or taking the action in conjunction with the computer); action details or description (e.g. mouse-click, text-input, keyboard command, etc.); the details of the window in which the action takes place, such as the window size, window name, etc.; the name of the program executing the window; and text if any that was input or submitted (in text actions). Other or different information may be collected. User details or ID may thus help to tie together actions input to a computer to related processes and infer process orderings.

Each low-level user action may be described in a database by several fields of an action data and/or information item such as action time, user details, action details, window name and size, program executing the window, and whether text was entered. A generalized name or description may also be created and associated with the action, where the generalized name has certain specific information such as user ID, timestamp, and other tokens in the data (e.g., names, dates, etc.) removed or replaced with generalized information. Multiple specific instances of similar actions may share the same generalized name or description. Thus, actions may be stored and identified by both identifying the specific unique (within the system) instance of the action, and also a generalized name or description.

Table 1 illustrates an example action data and/or information item for an example time frame and scenario in which an agent logs in into an ordering system which may for example be included or stored in a database or data store in memory 120; as with other data used in examples herein, other specific data and data formats may be used. The agent may open or start the ordering system, enter her or his username and password in a login screen, and then continue working on a case e.g., move to the new orders screen. This includes several low-level user actions as described in Table 1. First, the agent, identified as Agent1 in the User column, at time 10:00:00, clicks twice using a mouse left-click on the MyOrderingSystem icon on the desktop display (window Desktop indicates the desktop on a Windows style system, where windows may be displayed on the desktop). The login screen or window may open or pop up (named per collected data MyOrderingSystem-Login), and the agent may enter his username (e.g. “Agent1”) and password (e.g. “myPassword”) into the fields identified in the Action column, and successfully logs in. The text collected as data may be the entered agent name and password. The agent may then click on mouse left-click on the NewOrders view inside the MyOrderingSystem to display new orders.

TABLE 1

| | | | Action | |
|---|---|---|---|---|
| User | | | Description | Text |
| ID | Time | Window Name | or Type | Entered |
| Agentl | 10:00:00 | Desktop | Left-Dbl-Clickon | |
| | | | MyOrderingSystem | |
| Agentl | 10:00:10 | MyOrderingSystem- | InputText on | Agentl |
| | | Login | Username | |
| Agentl | 10:00:20 | MyOrderingSystem- | InputText on | myPass- |
| | | Login | Password | word |
| Agentl | 10:00:30 | MyOrderingSystem- | Left-Click on | |
| | | MainView | NewOrders | |

Data such as presented in Table 1 may generally be gathered or received from multiple physically distinct user terminals operated by multiple different users and is analyzed at a central location or server not at any of the user terminals (typically be a processor separate from terminal processors); however, data analysis may be performed at a user terminal which also collects user data. At for example a central server data received from the terminals describing the low-level user action information or items may be used to determine subprocesses, or routines, which may be for example a series or sequence of actions that repeat across the data, and possibly repeat across data divided into contexts. An item of information describing or defining a low-level user action may include for example an input type description (e.g., the type of action the user performed as input: mouse click, left click, right click, cut, paste, typing text, etc.), a user name, and screen window information such as title or name. (e.g., as computer processes in this context may be displayed as windows, each window may have a title or name which may describe the user-facing application to which the user provides input.) Actions may be stored and identified both identifying the specific unique (within the system) instance of the action, and also a generalized name or description that identifies the action in a way such that actions of similar functionality will have the same generalized name. Both the specific and generalized identification or name may be linked or stored together in the system. Sequential pattern mining may be applied to determine routines, each routine including a series of low-level user actions having multiple or repeating instances in the action data (see, in this context, further discussion on routine mining applied to variations produced by embodiments of the invention herein)

Additionally or alternatively, a list of actions may be saved in a database, data store, and/or a database module (which may be included or may include, for example, memory 120) in a JSON format as described herein, for example according to the following example format:

$$\begin{matrix}“ type : Click \text{",} \\ name : Left Click \\ is Selection : False \\ action Time : 2018-04-14 T 00 :56:17.0592647+05:30 \\ position : \{ X : 121 , Y : 238 \} \\ active Window : \{ \\ process Name : iexplore , title : RITM 0080385 | Service Now-Internet Explorer , \\ height : 603 , width : 1366 , top : 121 , left : 0 \} \\ action Component : \{ \\ Name : All applications Favorites Your history (tab) , Control Type : tab item , \\ Id : , Class Name : \} \\ text :\end{matrix}$$

Such JSON data structure, item, or object may for example be passed or transferred for further preprocessing, which may, e.g., be executed or performed by a preprocessing module as described herein.

Various fields in the JSON action data or information item provided herein (such as for example “isSelection”, “actionTime”, “position”, and the like) may be referred to as features or attributes of a given action. A plurality of attributes may be used in encoding a string representation such as a “word” or a “sentence”, as well as a vector representation or embedding of a given action by embodiments of the invention as further demonstrated herein.

Embodiments of the invention may produce a plurality of automation opportunities or candidates, such as for example sequences or subsequences of actions, or routines/processes, which may benefit from automation—based on an input query (which may, for example, be or describe a plurality of actions input to a computer, or a custom-built action sequence or process generated by a user or business analyst). For example, an input query for an automation discovery procedure may include a plurality of constraints and/or conditions, such as start and/or end events—which may be actions found in the beginning or end of the process to be automated—as well as intermediate events or actions which may be found between start and end actions. Automation opportunities or candidates produced provided by some embodiments of the invention may be, for example: a series of subsequently performed or execute actions, or action sequences, included or found in the low-level user action data explicitly satisfying the constraints and/or conditions included in the query, which may be referred to as “exact matches” of the query; sequences of actions or which may not explicitly satisfy the constraints and/or conditions included in the query but are found similar to exact matches as described herein, and may be referred to as “approximate matches”; and action sequences, subsequences or subprocesses extracted and/or mined from or based on exact and approximate matches, otherwise known as “variations”.

FIG. 2 shows an example input query and corresponding output matches to the query which may be used and/or produced by embodiments of the invention. An input query 210, which may be for example provided by a user, may include for example at least two events, which may be, e.g., a start event (e.g., opening a form or text file, or “open form” action), an intermediate event (e.g., “input text” action), and a stop event (e.g., pressing an “Apply” button action). Embodiments of the invention may index or segment a set of matching sequences or matches 212A-C based on the input query and stored user action data or information items (which may be included in a data store or dataset as described herein), which may for example collected from users within a given time frame, as further demonstrated herein. Matches 212A-C may include a plurality of action sequences of different lengths and/or durations (as illustrated by the horizontal dimensions and number of white boxes of each of bars 212A-C). In the particular non-limiting example under consideration, matches 212A-C are shown to include varying numbers of actions prior and/or subsequent to those included in the query, although constraints or requirements regarding match length may be used or implemented in different embodiments of the invention. Non-limiting examples of such constraints or conditions may include, e.g., allowing only results including X actions prior and/or Y actions subsequent to the input query, results including Z actions before or after the intermediate event in the input query, results of length found above/below/between predetermined thresholds, and the like—to be included in provided matches. Similar constraints or requirements regarding alternative variables or characteristics of output matches may be used in different embodiments of the invention.

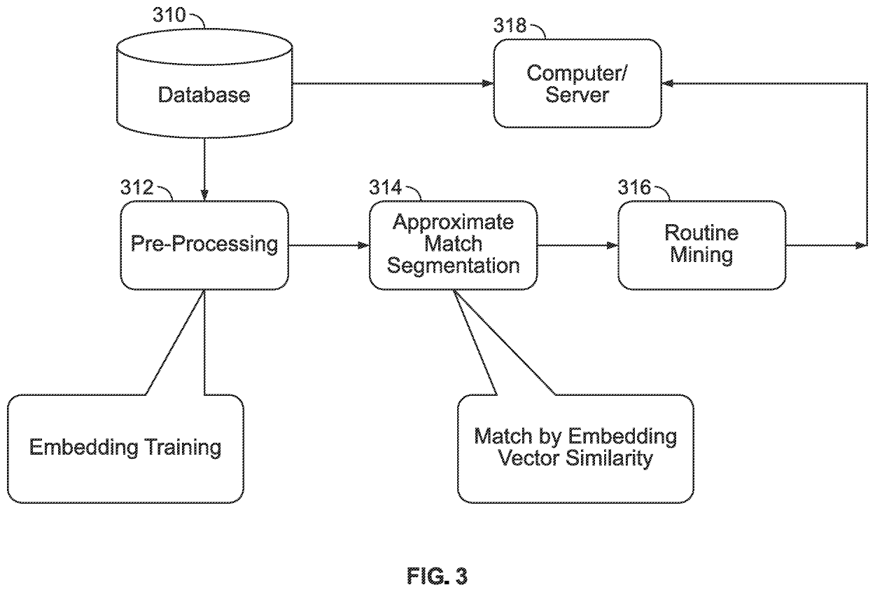

FIG. 3 illustrates an example workflow including different component and modules which may be used as in some embodiments of the invention. Database 310 (which may be for example a data store including a plurality of action data items included in memory 120 as described herein) may include a plurality of user action data, such as for example low-level user action data and/or information items as described herein (see, e.g., Table 1 and corresponding JSON data object). User action data and/or information items may input to preprocessing module 312, which may, for example, segment or index action data and/or information items into a plurality of action sequences, for example, according to or based on a given query which may be provided as input; encode or translate segmented sequences into string representations or “sentences”, for example based on a plurality of action features or attributes; label or tag sequences and/or sentences, e.g., as exactly matching or satisfying the conditions specified in the query; and train a machine learning model, such as for example a vector embedding model, based on the sentences (see further discussion on finding and labeling exact matches and on sentence-to-vector model training herein). Approximate match segmentation module 314 may subsequently, e.g., input both exact matches and non-exact match sequences or sentences into the model to calculate or generate a plurality vector representations or embeddings of the sequences or sentences; calculate or measure the similarity between pairs of sequences, each including, for example, one labeled or tagged sequences and one unlabeled or untagged sequence, based on the representations or embeddings (e.g., using similarity score calculations as further described herein); and add unlabeled sequences found similar to labeled ones (may also be referred to as “approximate matches”) to a group, set, or pool of all matches of the query, or all sequences similar to the query. Routine or process mining module 316 may then be applied, for example, to a plurality of actions sequences included in the resulting pool of matches or of similar sentences, to find, produce, or mine patterns, subsequences, or subprocesses of actions repeating within and/or across matching sequences as automation candidates, which may be referred to as “variations”. Embodiments may then calculate automation scores for the variations and/or automation candidates; include or document the scored candidates in a report, which may for example be displayed or visualized using an GUI by, e.g., a user or business analyst; and send or transmit the report, and/or an instruction to automatically execute, for example, a computer operation, routine, or process (such as for example an automation candidate for which a high automation score was calculated), or a plurality of such, to computer or server 318, for example based on the mined or produced automation candidates. In some embodiments, computer or server 318 may be the same computer which includes database 310 and executes modules 312-316 (e.g., system 100), while in other embodiments computer or server 318 may be remote, distinct and physically separate computing system or cloud-based platform.

Embodiments of the invention may include a sentence-to-vector (S2V) or document-to-vector (D2V) model, which may be based, for example on a machine learning (ML) and/or artificial neural network (NN) framework. The S2V model may be trained on a collection or set of input action data and/or information items segmented into action sequences and encoded or translated into strings or “sentences” as described herein.

A sentence—or set of “words”—as used herein may thus correspond to a plurality of encoded or translated, and/or concatenated strings describing actions and their attributes and/or features (which may be, e.g., low-level user actions as provided in data and/or information items such as Table 1 and the corresponding JSON object provided herein).

Embodiments may encode or translate each given action and its attributes and/or features into a word or string representation. The encoded string may include a plurality of corresponding fields or entries, according to predefined encoding and/or translation formatting procedures or rules. Encoded fields and corresponding values may be, for example:

TABLE 2

| Field | Format (+Notes) | Example Value |
|---|---|---|
| Action_type | Number (associated with each | 1000 |
| | type_ID) | |
| Is_selection? | Boolean | 0 |
| Action_duration | Number (of seconds required to | 5.5 |
| | complete the action) | |
| Action_text_length | Number (of letters in text) | 6 |
| Application_title | String (encoded as is, without | CRM_Form |
| | modifications) | |
| GUI_control_ID | The GUI object manipulated by | Text_box_5341 |
| | the user within the application | |
| | (e.g., a button, free text field, | |
| | etc. It has a unique string | |
| | identifier, which is encoded as | |
| | is, without modifications) | |

As a non-limiting example, the “Action_duration” attribute may be encoded by embodiments of the invention into a field based on a “bucket” representation, where a predefined bucket of values is given (such as, e.g., [0, 1, 2, 4, 8, 10, 15, . . . ]). In such bucket representation, the measured action duration, which may be, e.g., 5.5 seconds—may be encoded to the closest value included in the bucket that is equal or smaller to it (e.g., 4). Different fields or attributes, such as “Action_type” and/or additional action identifiers, may be for example determined according to predetermined rules and/or conditions, or otherwise randomly and/or arbitrarily.

Alternative encoded strings or sentences including, e.g., different fields and/or formats based on various encoding principles (including or involving, for example, One Hot encoding) or rules may generally be used in different embodiments of the invention.

Words or sentences may, in some embodiments, include a number of fields larger than the number of attributes in the input data. For example, various encoded fields or attributes of a given action or of a plurality of actions may be further concatenated with additional underscore attributes or fields to produce a final word representation. For example, for an initial word ‘1000_0_5.5_6_CRM_Form_Text_box_5341’, embodiments may provide a revised or concatenated word ‘1000_0_30_5.5_6_40_CRM_Form_Text_box_5341’ including underscore attributes or fields ‘30’, ‘40’. Concatenating underscore attributes or fields may thus be determined according to a plurality of conditions and/or criteria and/or based on additional attributes or features. For example, for an action characterized by Action_type=1000 (See, e.g., example in Table 2), and being a non-selection option (Is_selection=0), an underscore field of ‘30’ may be added between the “is_selection?” and “action_duration” fields. In a similar manner, an underscore field of ‘40’ may be added based on the values of the “action_duration” and “action_text_length” fields. In some embodiments, underscore attributes may be generated, determined, or calculated by the S2V model, for example after being trained on a corresponding corpus of sentences. Additional or alternative procedures or schemes for determining concatenating, underscore attributes or fields may be used in different embodiments of the invention. A combination of word representations or words for a plurality of actions may form a sentence, which may be used as training data and/or as input for a S2V model. While the underscore character (_) is used in one example to concatenate text describing actions, other characters or methods may be used.

The S2V model may be trained and configured to produce vector representations or embeddings of sentences and/or words. For example, embodiments may translate or embed a sentence ‘1_2_3_4’ into a vector embedding [E(1), E(2), E(3), E(4) . . . E(n)], where each E(n) may be, for example, an embedding of each word ‘n’ in the sentence and/or an embedding derived from a latent space which includes, inter alia, the entirety of the words appearing in the sentence. The size n for vector embeddings produced by the model in embodiments of the invention may for example be chosen and/or tuned, e.g., such that desirable model performance and/or statistical robustness are achieved. In some embodiments, word embeddings may be further assigned or combined with a paragraph vector T—to produce a final embedding such as, e.g., [E(1), E(2), E(3), E(4), . . . E(n)], T]. In some embodiments, paragraph or document vector T may be or may include a unique sentence or paragraph ID (such as for example a number), and/or a tagging or labeling entry which may, for example, include, reflect, or correspond to tagging or labeling the sentence and/or corresponding embedding as described herein and according to model requirements (such as, e.g., a binary entry where ‘1’ signifies an exact match of a given query, and ‘0’ signifies “remainder”, or non-exact-match—see corresponding discussion herein). In some embodiments, paragraph vectors (and a corresponding tagging or labeling of sentences as matching or unmatching an input query) may be assigned, calculated or determined by the S2V model and combined with word embeddings produced by the model. It should be noted, however, that additional or alternative sentence or document embedding procedures and methods may be used in different embodiments of the invention.

In some embodiments, the S2V model may be constructed and/or trained such that for each unique sentence and/or paragraph ID, which may be included in paragraph vector T of a vector embedding input to the model, a single word representing a particular action will be predicted with high probability (exceeding, for example, a predetermined threshold). In this context, a plurality of identifiers may be generated for a plurality of paragraph vectors, as well as for the plurality of words included in the action data, for example, such that unique identifiers or IDs exist for each paragraph vector and word included in the training data input to the model. A NN may be set up to receive a plurality of encoded action sequences or sentences; produce or output a paragraph vector T for each of the sentences (including a label and unique identifier as described herein) at a first layer of the NN; and pass the output Ts to a second, SoftMax layer of the NN to output probabilities for predicting, e.g., a given word (which may for example be described by a unique identifier) from each sentence for which a given T was produced. During NN training, sets of NN weights for both first and second layers may be adjusted or optimized, resulting in producing paragraph vectors Ts which may predict the selected word with the highest probability, or with a probability above a predetermined threshold, and in the second layer (e.g., the SoftMax layer) having appropriate prediction performance statistics (e.g., matching or satisfying a set of predetermined conditions or criteria). It should be noted, however, that alternative S2V and NN architectures and model training procedures may be used in different embodiments of the invention.

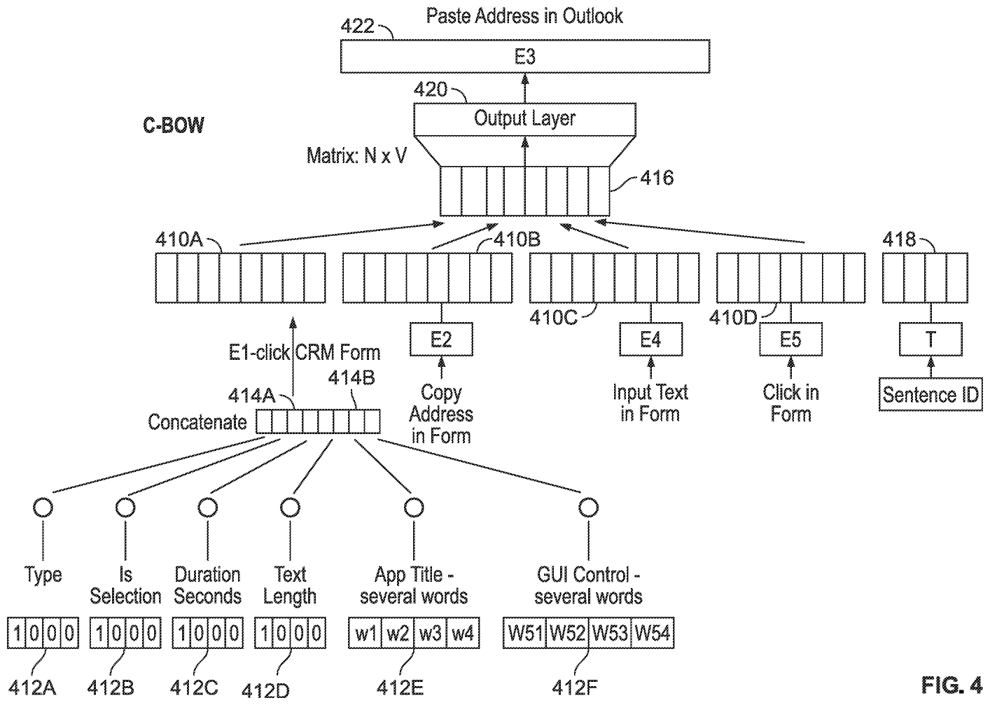

FIG. 4 illustrates an example S2V model training procedure according to some embodiments of the invention. A sentence input to the model may include action words 410A-D containing a plurality of attributes or fields such as, e.g., 412A-F, which may for example be concatenated by underscore attributes 414A-B. In some embodiments, the S2V model (which may, for example, conform to a continuous-bag-of-words (CBOW) architecture as known in the art, although different architectures may be used in different embodiments of the invention) may produce or provide a vector embedding or representation of an N×V matrix 416 of the sentence, where N is the vector size, which may be for example the total number of word embeddings as well as of additional embeddings derived from a latent space as described herein, and V is the vocabulary size, which may be, for example, the total number of unique identifiers for all words as well as paragraph vectors generated by the model. A paragraph vector 418 may be added to the sentence, or to a vector embedding of the sentence, which may for example label the sentence as an exact match of an input query and include a unique sentence identifier Output layer 420 of the S2V model may then predict, produce or output a word 422, which may, for example, not be included in the input sentence. As noted herein, both assigning paragraph vector 418 and predicting word 422 may be optimized as part of S2V model training—that is, NN weights for an output layer and an intermediate layers may be adjusted to improve prediction statistics. In some embodiments, optimization and prediction cycles may be performed in an iterative manner.

The resulting, trained S2V model may then be used for generating or calculating vector representations or embeddings sequences such as of exact matches and non-exact matches—based on which similarity scores may be calculated as further described herein.

Procedures and/or steps which may be performed by embodiments of the invention (e.g., by the modules considered in FIG. 3) may now be outlined in greater detail.

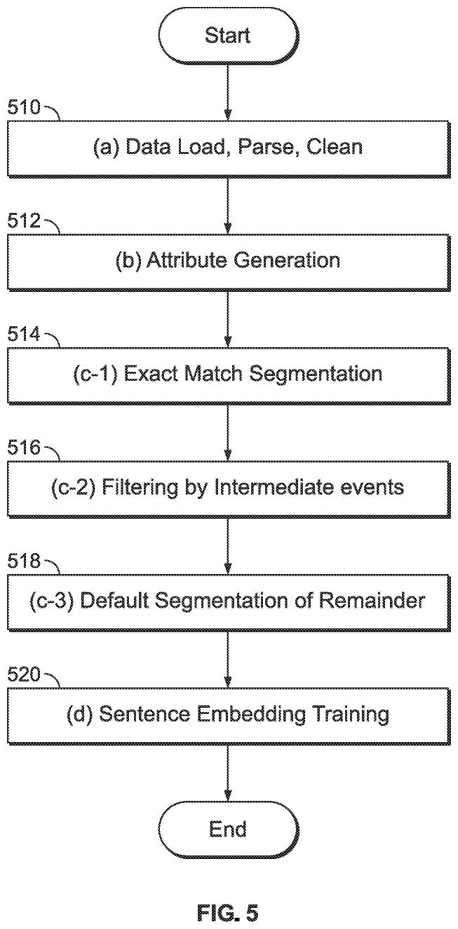

FIG. 5 depicts an example data preprocessing and model training procedure which may be used in some embodiments of the invention. The processing procedure outlined herein may begin upon receiving an input query—which may include for example start, end, and intermediate events as described herein. In step 510, training data such for example as low-level user action data and/or information (which may, e.g., conform to the example formats provided herein) describing a plurality of actions, may be received or loaded (e.g., from a data store or database in memory 120), and additionally or optionally further cleaned or parsed, e.g., according to data curation methods and procedures known in the art.

In some embodiments, user action data and/or information items which may be used as training data and/or, e.g., indexed or segmented by embodiments of the invention as described herein, may collected from a plurality of remote computers (e.g., ones operated by agents or users), e.g., via a communication network, over a given time frame or a plurality of time frames. The time frame and the set of remote computers from which action data are collected may be determined manually, such as for example by a business analyst. In other embodiments, such variables may be predetermined, for example according to predetermined conditions or criteria (for example, action data may be collected from a given remote computer, or from a set of remote computers, once in X days, for a time frame of Y hours). Alternative procedures, conditions or criteria for determining the collecting or action data from particular remote computers, and the time frame for the action data to be collected, may be used in different embodiments of the invention.

Embodiments may then read, extract, or generate a plurality of attributes or features of documented actions (step 512), such as for example ones included in Table 1, which may for example subsequently be used for encoding actions into words as described herein.

Embodiments may then segment or index a plurality of actions (e.g., included in a data store or data base in memory 120) into action sequences based on the input query and, e.g., action features and/or attributes such as for example the execution time for each action (steps 514-518). Thus, in step 514, embodiments may find all occurrences or instances of an action specified as the start event which are followed (e.g., based on execution times or timestamps) by an action specified as the end event—and segment or index such instances, as well as the plurality of actions executed between the pair of start and end actions, as action sequences. Action sequences found or indexed in step 514 may be further screened and/or filtered based on, e.g., intermediate events included in the input query (step 516). Filtered sequences including actions specified as intermediate events may then be categorized or labeled as “exact matches” of the input query (which may, for example, be implemented in further assigning, by the S2V model, a paragraph vector T to a sentence representing the exact match, as demonstrated herein). The remaining action data and/or information items may subsequently be segmented or indexed into action sequences, e.g., based on intervals in action execution times (for example, a timeframe of length n, e.g., in seconds, during which no action was executed may indicate that a given action sequence has ended and another, subsequent sequence begins—and action data may thus be segmented or indexed accordingly; various additional or alternative segmentation methods, however, are known in the art and may be used in different embodiments of the invention; step 518).

Segmented or indexed action sequences may be encoded into strings or sentences, for example based on attributes or features and according to encoding principles as described herein (to include, for example, underscore attributes and/or to be assigned a paragraph vector T, e.g., by the S2V model). Subsequently, the S2V model may be trained, e.g., based on the set or corpus of all encoded sentences (including both exact matches and remaining sentences; step 520), e.g., according to word prediction statistics as demonstrated herein.

In some embodiments of the invention, data preprocessing procedure may output, for example, a plurality of output data structures, each including or describing, e.g., actions, attributes, a list or sequence of actions, words and/or sentences representing actions, and the like. Such output data structures may, for example, be used as an input for an approximate match segmentation procedure as described herein. Output data structures may be produced, for example in a text file or JSON data or information item format, although alternative formats may be used in different embodiments of the invention. An example data structure describing an action which may be received as the output (and for example be stored and/or included in a database or data store in memory 120) of a preprocessing procedure may be, e.g.:
ID: 32 (unique running number for every action in the training data)
Type: “Click”
Name: “LeftClick”
actionTime: “2018-04-14T00:56:17.0592647+05:30”
position: (121, 238)
isCopyAction: “False”
isPasteAction: “False”
isSelection: “False”
text: “ ”
textLength: 0
numberOfWords: 0
Ctrl: “False”
Alt: “False”
Shift: “False”
processName: “iexplore”
processtitle_parsed: “alphanumeric|ServiceNow”
controlIdentifier: “All applicationsFavorites Your history(tab)”
controlType: “tab item”
controlClassName: “ ”
Description_parsed: “User Click(LeftClick) on All applicationsFavorites Your history(tab) in alphanumeric|ServiceNow—iexplore”
ActionDuration: 3
Description_ID: 56201 (unique ID for action type)
   In some embodiments, additional or higher-level data structures (including or describing, e.g., action sequences or sentences) may be generated as combinations or concatenations of data structures and/or information items describing single actions. In some embodiments of the invention, some fields of the preprocessing output (e.g., “actionTime”) may be taken or derived directly from the underlying low-level user action data (see, e.g., Table 1 and JSON data object demonstrated herein) while other fields (e.g., identifiers, “alphanumeric|ServiceNow”) may be newly generated as a product of the preprocessing procedure—for example as summarizing or encapsulating a plurality of attributes included in the action data. Additional or alternative fields and/or data structure formats may be used in different embodiments of the invention and stored in memory 120.

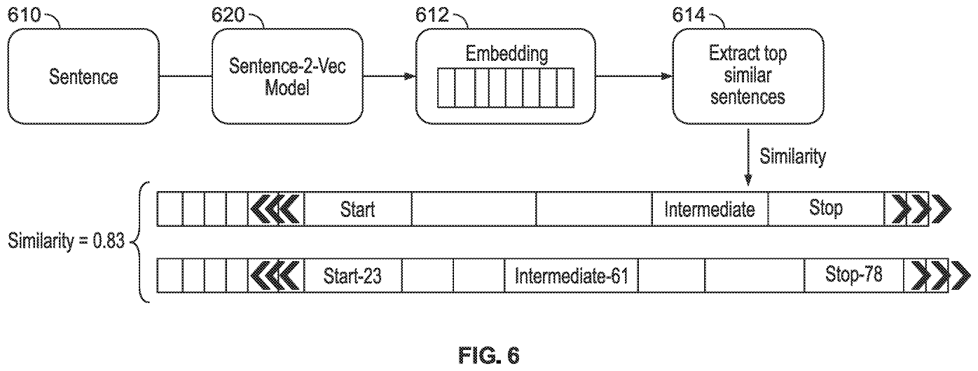

FIG. 6 depicts an example approximate match segmentation procedure according to some embodiments of the invention. In step 610, a collection or set of sequences or sentences (which may be encoded, e.g., as part of a preprocessing procedure as described herein, and including exact matches and non-exact matches to a given input query) may be received as input. A S2V model 620 (which may be for example trained as demonstrated herein) may then output, produce or provide vector embeddings or representations of input sequences or sentences (step 612). For each vector embedding S₁ representing an exact match to the input query, embodiments may calculate a plurality of similarity scores sim(S₁, Sₙ) measuring the similarity or difference from different exact matches and/or non-exact matches (e.g., S₂, S₃ . . . Sₙ; step 614).

Embodiments of the invention may calculate similarity scores for pairs of vector representations or embeddings (e.g., between exact and non-exact matches as described herein). In some embodiments, a similarity score sim(S₁,S₂) may be or may include measuring a distance between a pair of vector representations or embeddings S₁ and S₂ using a cosine similarity or distance formula, such as for example:

$$sim ( {S}_{1} , {S}_{2} ) = \frac{{S}_{1} \cdot {S}_{2}}{‖ {S}_{1} ‖ \cdot \vert \vert {S}_{2} ‖} \qquad ( eq . 1 )$$

although alternative similarity score formulas and calculation procedures may be used in different embodiments of the invention. Eq. 1 may output scores between 0.00 (no similarity) and 1.00 (full similarity). In some embodiments of the invention, vector representations or embeddings describing non-exact matches for which a calculated similarity score is found to exceed a predetermined threshold may thus be categorized or labeled as “approximately matches”, or as “similar” to exact matches and the input query. For example, given that Sₙ is describes a non-exact match—if the calculated similarity score for S₁ and Sₙ exceeds a predetermined threshold T=0.75, then Sₙ may be regarded, labeled, or categorized as an approximate match.

Following the calculation of similarity scores, all approximate matches—e.g., the action sequences represented or described by corresponding vector embeddings used as part of similarity score calculation—may be clustered or grouped into a pool or set of similar sentences including, e.g., all exact matches and approximate matches, while the remaining action sequences may be discarded. It should be noted that, in some embodiments, similarity thresholds may be modifiable and/or determined manually, e.g., by a user or business analyst, according to various preferences and/or performance considerations.

A set, group, or pool of similar sentences (such as for example that of all action sequences corresponding to exact and approximate matches) may be stored in system memory 120 (e.g., in a dedicated data store or database, or in an existing data store or data base storing additional data structures produced by embodiments of the invention) given as input to a routine or processes mining procedure, e.g., to be mined for patterns or action subsequences or subprocesses based on the plurality of similar sentences, where patterns or action subsequences or subprocesses may be repeating in and/or across the matches. In this context, routine or process mining module 316 may for example access or load a plurality of action sequences such as matches to the input query, e.g., from the corresponding database or data store in memory 120, and perform routine or subprocess mining procedure on such sequences. Mined subsequences or subprocesses may be referred to as “variations”. Similarity scores calculated for a pair or a set of matches (e.g., exact and approximate ones) may be assumed to indicate, e.g., that highly similar subsequences of actions and/or routines are included in the pair or set of matches. Thus, similar matches—and/or actions sequences, subsequences or subprocesses mined based on them—may be grouped, identified, and/or regarded as a single routine or process. Different mined sequences in a single grouped routine or process may thus be considered or referred to as a “variation”, or automation candidate, in automation discovery and/or identification procedures according to embodiments of the invention.

In order to measure and/or quantify the potential utility or benefit which may be associated with identified automation candidates or variations, automation scores may be calculated for variations mined or abstracted from exact and approximate matches. Automation scores may, for example, be based on a plurality of factors, such as, e.g.: the number of instances or recurrences of the variation in the corresponding exact or approximate match sequences grouped as a single routine or process; the identity of particular actions included in the variation (as may be reflected, e.g., in a plurality of action IDs); the length of the variation, as may be reflected for example in time required to execute all actions, or the total number of actions included in the variation, and the like. Various automation scoring approaches and procedures are known in the art and may be used in different embodiments of the invention.

Variations or sequences extracted, mined or abstracted based on exact and approximate matches may be given or be associated with a plurality of corresponding attributes. In some embodiments, each variation may be documented or stored, e.g., as data structure in a data store or database in memory 120 (e.g., in a manner similar or analogous to additional data structures which may be produced by embodiments of the invention)—which may include a plurality of attributes and/or lists, such as for example:
sequence_description_IDs—a list of the actions' “Description_ID” attributes (see, e.g., example data structure provided as output of the preprocessing procedure as described herein).
support—the number of times the sequence occurs within the action data (such as, e.g., within matches to the input query, or within the action data input to the model such as for example model 620).
description—a list of the actions' “Description_parsed” attributes (see additional data structures herein).
sequence_len—the number of actions in the sequence.
processNames—a list of the actions' “processName” attributes.
processtitles_parsed—a list of the actions' “processtitle_parsed” attributes.
sequence_actionIDs—a list of lists. Each list may describe an instance of the sequence in the user action data or within matches to the input query, and may include a plurality of action ID attributes describing the instance.
sequence_durations—a list of the durations each instance of the sequence (e.g., in seconds).
sequence_mean_time—an average value of the durations in “sequence_durations”.
total_time—sum of the durations in “sequence_durations”.
score—a calculated automation score indicating the automation value of the sequence.
routine_ID—an identifier of the routine or process abstracted from a plurality of matches to the input query (which may have been grouped based on their similarity as described herein).
routine_score—a weighted score for all sequences or variations included in the routine (e.g., the average of the “score” attributes for the variations).
routine_support—a sum of the variations' “support” attributes.
routine_total_time—a sum for the variations' “total_time” attributes.
sequence_title—the string display name of the sequence.
sequence_type—the routine/process type (e.g. Copy-Paste, Data-Entry, Template).
   One skilled in the art would recognize, however, that different data structure formats and/or corresponding entries may be used in different embodiments of the invention.

Routine mining module 316 may document or include a plurality of matches or variations, and/or mined or identified automation candidates (such as for example subsequences or variations), in a report—which may be, for example, reports as used in the AD framework considered herein, and may be displayed or visualized on an GUI of, e.g., a remote computer operated by a business analyst. In such report, each of the variations or mined routine/process may point or be linked to its instances in the low-level user action data and/or information items (used as, e.g., input to preprocessing module 312 as described herein), or in sequences found as matches to the input query as described herein.

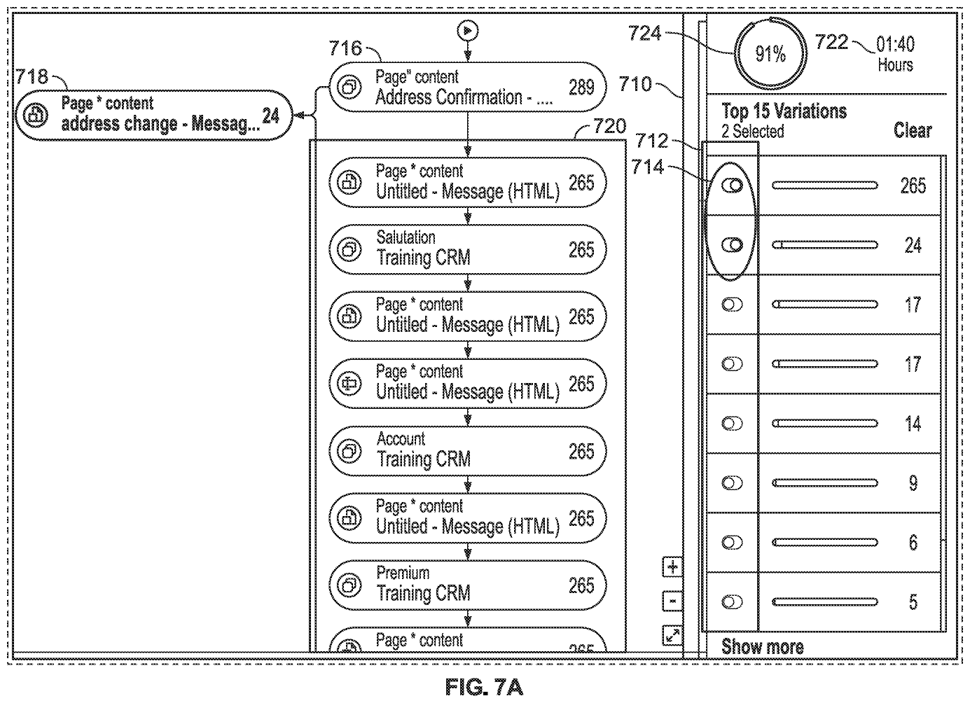

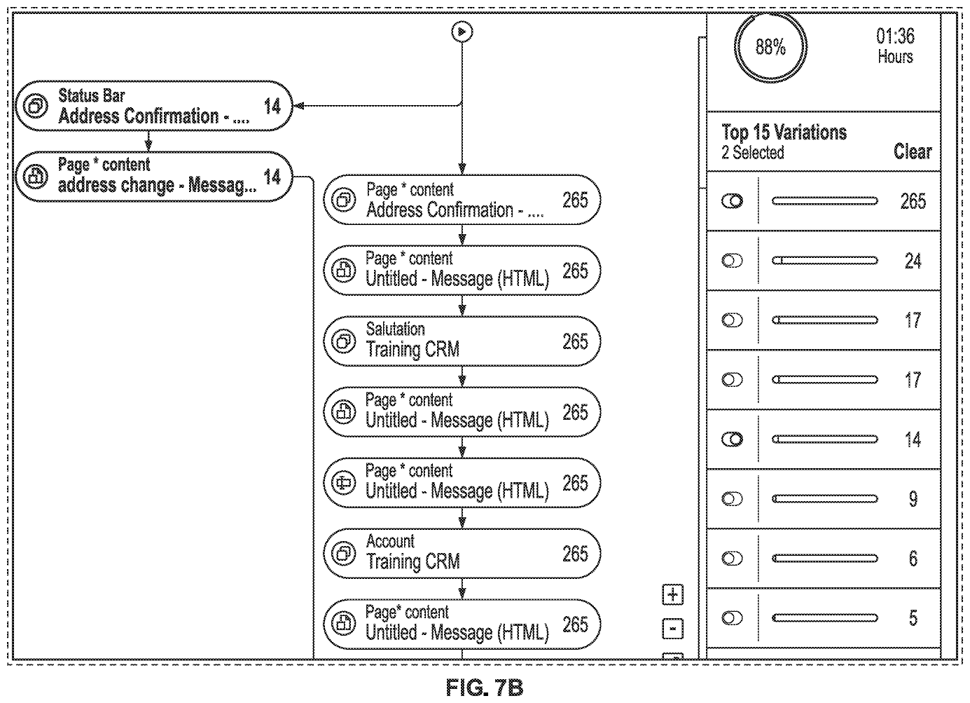

FIG. 7A-B depicts an example report GUI visualization according to some embodiments of the invention. Right pane 710 may list variations according to, e.g., calculated automation scores (where “top” variations may be the variations having the largest number of instances in user action data and/or information items). A user, such as for example a business analyst, may select a plurality of the variations by, e.g., clicking on buttons 712. Upon selection of variations, the report may include a plurality of underlying actions and their occurrences in instances of the selected variations included in the user action data or matches to the input query. For example, for the two selected variations 714—the first selected variation having 265 instances, and the second selected variation having 24 instances in the user action data—action 716, labeled as “Address Confirmation” is shown to occur 289 times, indicating that it is included in all instances of the two selected variations. Actions included only in the second selected variation, such as action 718 which accordingly occurs only 24 times in the user action data—may be displayed to the left of actions included in the first selected or top variation, such as actions 720 which accordingly occur only 265 times in the use action data. In addition, an overall time measured for the execution of all instances of the selected variations 722, and a percentage of instances of selected variations among instances of all variations included in the report 724 may be presented. FIG. 7B illustrates another GUI representation of two variations or automation candidates produced by some embodiments of the invention—where the first selected variation is identical to the first selected variation in FIG. 7A, and the second selected variation is different than that of FIG. 7A and shown to occur 14 times in the underlying user action data and/or information items under consideration. It should be noted that alternative visualizations and/or GUI representations of variations and/or related data or information may be used in different embodiments of the invention.

Automation candidates and/or a plurality of variations and/or action sequences, as well as individual computer operations may be automatically executed on a remote computer, or by a plurality of remote computers, based on an instruction sent or transmitted by embodiments of the invention. For example, based on the example action sequence provided in Table 1, embodiments may produce or provide an automation data item formatted as a table or as a JSON object, such as, e.g.:

TABLE 3

| Action | | Action Description | |
|---|---|---|---|
| Number | Window Name | or Type | Input Text |
| 1. | Desktop | Left-Dbl-Clickon | |
| | | MyOrderingSystem | |
| 2. | MyOrderingSystem- | InputText on Username | Agentl |
| | Login | | |
| 3. | MyOrderingSystem- | InputText on Password | myPassword |
| | Login | | |
| 4. | MyOrderingSystem- | Left-Click on NewOrders | |
| | MainView | | |

which may subsequently be sent or transmitted to a remote computer, on which the automation sequence may be automatically executed, for example by a bot. In some embodiments, a remote computer may be configured to further process the received data item or automation, to produce an additional file or data item readable by an automation, program or process execution interface or platform—such as for example the Automation Finder platform by Nice Ltd used as part of the AD framework used as an example herein. A remote computer, or a plurality of remote computer, may thus execute or perform the corresponding automation (which may itself be produced or provided, e.g., as an exact match or variation output by embodiments of the invention based on an input query as described herein) in desirable contexts, according to conditions or criteria implemented in the interface or platform (for example, repeatedly, n number of times, following an action or sequence of actions performed by that remote computer which may determine the triggering of automation execution, and/or at a specific time determined for the automation based on user action data, and the like). Additionally or alternatively, embodiments may create a bot on a computer system or a plurality of computer systems (which may for example be physically separate and remote from system 100), which may, in turn, perform or execute a plurality of automation candidates such as matches and/or variations provided by embodiments of the invention (e.g., based on automation scores calculated for the automation candidates). It should be noted that alternative automation data item formats, as well as execution conditions and/or criteria and/or executing entities, may be used in different embodiments of the invention.

Embodiments of the invention may improve automation discovery technology aimed at identifying automation candidates, which may be, for example, computational processes or routines which may benefit from being fully computer-automated instead of manually executed (e.g., by a human user). Previous systems and methods for conducting semi-supervised automation discovery procedures are based on searching automation candidates explicitly matching an input provided by a human user—which may include a plurality of specific parameters according to which candidates are to be identified (such as for example being executed using a particular computer program, and so forth). Embodiments of the invention may allow discovering unknown automation candidates not explicitly matching parameters specified as input (such as variations based on approximate matches as described herein), according to their semantic similarity to known candidates (e.g., exact matches). Thus, embodiments of the invention may allow augmenting the search space used in such semi-supervised automation discovery methods and procedures in a controlled manner, by providing automation opportunities not explicitly searched for, and yet being functionally equivalent or similar to additional opportunities found using known or previous solutions. Embodiments may improve the technology of computer bots by for example allowing computer bots to be created on a plurality of computer systems on which automation candidates provided by embodiments of the invention may be automatically executed. Such bots may be created or constructed to automatically execute a plurality of automation candidates such as matches and/or variations (which may for example be ranked or graded based on calculated automation scores as described herein), e.g., on a computer system such as system 100 or on a plurality of remote computers as described herein.

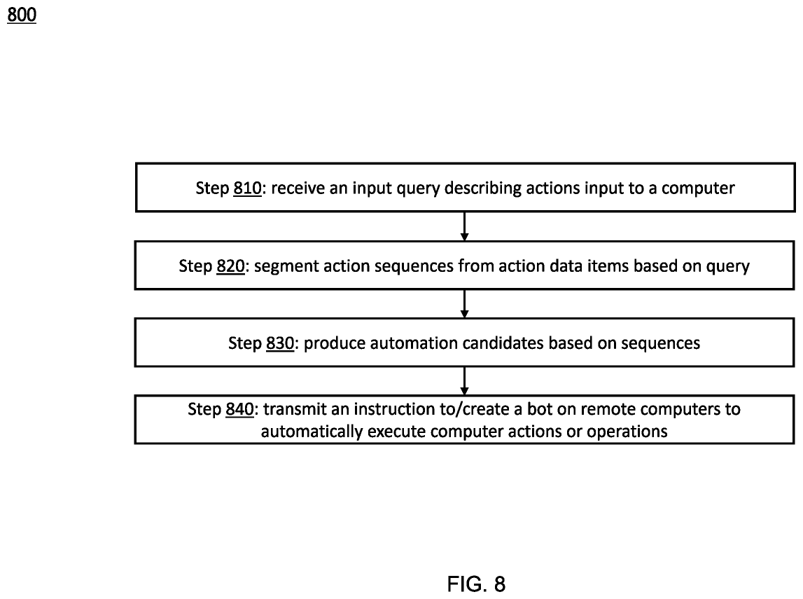

FIG. 8 is a flowchart depicting an example automation discovery and analysis procedure 800 according to some embodiments of the invention. In step 810, a computer processor or a plurality of processors may be configured to receive an input query, which may for example describe a process including actions input to a computer. Embodiments may then segment or index a plurality of action sequences from action data and/or information items (which may, e.g., be collected from remote computers and stored in memory 120 as demonstrated herein) based on the input query (step 820). A plurality of automation candidates may then be produced based on segmented of indexed action sequences (step 830). Embodiments may further transmit an instruction to, or create a bot on, a plurality of remote computers based on the produced automation candidates, instruction or bot to automatically execute computer actions or operations on the remote computers (step 840). An automation discovery and analysis procedure such as for example procedure 800 may thus be used to replace human input, such that, e.g., a bot may automatically execute computer operations without requiring a human user performing computer actions manually.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for automation discovery using action sequence segmentation, the method comprising:
in a computerized system comprising one or more processors, and a data store of a plurality of data items describing one or more actions input to a computer:
receiving an input query describing a process, the process comprising one or more actions input to a computer;
segmenting, by one or more of the processors, a plurality of action sequences from one or more of the data items based on the query; and
producing, by one or more of the processors, one or more automation candidates based on the sequences.

2. The method of claim 1, comprising:
labeling, by one or more of the processors, one or more of the sequences matching the query;
for one or more pairs of sequences, each pair including one of the labeled sequences and one unlabeled sequence, calculating, by one or more of the processors, a similarity score; and
for each pair, if the similarity score exceeds a predetermined threshold, adding, by one or more of the processors, the unlabeled sequence to a set of similar sequences; and
wherein the producing of one or more of the automation candidates is performed based on one or more of the similar sequences.

3. The method of claim 2, comprising:
encoding, by one or more of the processors, the sequences into one or more sentences;
training a machine learning (ML) model based on the sentences; and
generate, by the model, one or more vector representations for the sentences; and
wherein the calculating of a similarity score comprises measuring a distance between a pair of vector representations.

4. The method of claim 2, wherein the producing of one or more of the automation candidates comprises mining, by one or more of the processors, one or more action subsequences based on the set of similar sequences; and
wherein the method comprises calculating, by one or more of the processors, one or more automation scores for one or more of the automation candidates.

5. The method of claim 3, wherein the labeling of one or more of the sequences comprises assigning, by the model, one or more paragraph vectors to one or more of the representations.

6. The method of claim 3, wherein one or more of the sentences include one or more attributes of one or more of the actions, the attributes concatenated by one or more underscore fields.

7. The method of claim 1, comprising transmitting an instruction to one or more remote computers based on one or more of the automation candidates, the instruction to automatically execute at least one computer operation on one or more of the remote computers.

8. The method of claim 1, comprising documenting, by one or more of the processors, one or more of the automation candidates in a report; and
displaying the report on a graphical user interface (GUI) of a remote computer.

9. The method of claim 1, wherein the input query comprises at least two of: a start event, an end event, and an intermediate event.

10. A computerized system for automation discovery using action sequence segmentation, the system comprising:
one or more processors,
and
a memory including a data store of a plurality of data items describing one or more actions input to a computer;
wherein one or more of the processors are to:
receive an input query describing a process, the process comprising one or more actions input to a computer;
segment a plurality of action sequences from one or more of the data items based on the query; and
produce one or more automation candidates based on the sequences.

11. The computerized system of claim 10, wherein one or more of the processors are to:
label one or more of the sequences matching the query;
for one or more pairs of sequences, each pair including one of the labeled sequences and one unlabeled sequence, calculate a similarity score; and
for each pair, if the similarity score exceeds a predetermined threshold, add the unlabeled sequence to a set of similar sequences; and
wherein the producing of one or more of the automation candidates is performed based on one or more of the similar sequences.

12. The computerized system of claim 11, wherein one or more of the processors are to:
encode the sequences into one or more sentences;
train a machine learning (ML) model based on the sentences; and
generate, by the model, one or more vector representations for the sentences; and
wherein the calculating of a similarity score comprises measuring a distance between a pair of vector representations.

13. The computerized system of claim 11, wherein one or more of the processors are to:
mine one or more action subsequences based on the set of similar sequences; and
calculate one or more automation scores for one or more of the automation candidates.

14. The computerized system of claim 12, wherein one or more of the processors are to assign, by the model, one or more paragraph vectors to one or more of the representations

15. The computerized system of claim 12, wherein one or more of the sentences include one or more attributes of one or more of the actions, the attributes concatenated by one or more underscore fields.

16. The computerized system of claim 10, wherein one or more of the processors are to transmit an instruction to one or more remote computers based on one or more of the automation candidates, the instruction to automatically execute at least one computer operation on one or more of the remote computers.

17. The computerized system of claim 10, wherein one or more of the processors are to:
document one or more of the automation candidates in a report; and
display the report on a graphical user interface (GUI).

18. The computerized system of claim 10, wherein the input query comprises at least two of: a start event, an end event, and an intermediate event.

19. A method for automation discovery using a vector embedding model, the method comprising:
in a computerized system comprising one or more processors, and a data store of a plurality of data items describing one or more actions input to a computer:
receiving an input query describing one or more actions input to a computer;
indexing, by one or more of the processors, a plurality of action sequences from one or more of the data items based on the query;
tagging, by one or more of the processors, one or more of the sequences matching the query;
translating, by one or more of the processors, the sequences into one or more sentences;
training at least one neural network (NN) based on the sentences;
calculating, by the NN, one or more embeddings for the sentences;
for one or more pairs of sequences, each pair including one of the tagged sequences and one untagged sequence, calculating, by one or more of the processors, a similarity score based on the embeddings;
for each pair, if the similarity score exceeds a predetermined threshold, adding, by one or more of the processors, the unlabeled sequence to a set of similar sequences; and
producing, by one or more of the processors, one or more automation candidates based on one or more of the similar sequences.

20. The method of claim 19, wherein the producing of one or more of the automation candidates comprises:
grouping, by one or more of the processors, one or more of the similar sequences into one or more processes;
extracting, by one or more of the processors, one or more subprocesses based on one or more of the processes; and
calculating, by one or more of the processors, one or more automation scores for one or more of the subprocesses.
